(19) United States
(12) Patent Application Publication
(10) Pub. No.: US 2024/0354065 A1
(43) Pub. Date: Oct. 24, 2024

(54) Machine Learning for Automated Development of Data Schema from Natural Language Inputs

(71) Applicant: Google LLC, Mountain View, CA (US)

(72) Inventors: Phillip John Stephens, Niwot, CO (US); Preetham Mysore, Brooklyn, NY (US)

(21) Appl. No.: 18/639,470

(22) Filed: Apr. 18, 2024

Related U.S. Application Data
(60) Provisional application No. 63/496,848, filed on Apr. 18, 2023.

(51) Int. Cl. G06F 8/30

(52) U.S. Cl. CPC G06F 8/30

(57) ABSTRACT

Provided are systems and methods that leverage a machine-learned language model to perform automated generation and/or modification of a data schema for a software application based on natural language inputs. For example, the techniques can be implemented as part of or by an application development platform that enables users to develop software applications using low-code or no-code tools.

### RELATED APPLICATIONS

This application claims priority to and the benefit of U.S. Provisional Patent Application No. 63/496,848, filed Apr. 18, 2023. U.S. Provisional Patent Application No. 63/496,848 is hereby incorporated by reference in its entirety.

### FIELD

The present disclosure relates generally to the use of machine learning for the automated development of software applications. More particularly, the present disclosure relates to systems and methods that leverage machine learning models to perform automated generation and/or modification of a data schema for a software application from natural language inputs.

### BACKGROUND

While many individuals may wish to create or develop software applications, they may not have the necessary knowledge or skills to correctly develop a working software application. In particular, the development of software applications requires a specific set of skills, and/or resources, which may not be readily available or accessible to most people. As a result, many individuals may not know how to create software applications due to the technical complexity, lack of programming skills, limited resources, time and effort requirements, rapidly changing technology landscape, and/or cost implications.

Even for individuals that are skilled at software development, the process of developing a software application typically occurs over a number of iterations in which a user (e.g., developer) proceeds incrementally through repeated cycles of planning, designing, building, testing, and refining the software application code. Software development according to such an iterative process can consume significant computing resources, including processing power, memory, storage, and other system resources, due to the repeated cycles of development, testing, deployment, monitoring, and communication involved in the iterative development process.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for automated software development. The method includes obtaining, by a computing system comprising one or more computing devices, a natural language description of a software application. The method includes processing, by the computing system, the natural language description with a machine-learned language model to generate, as an output of the machine-learned language model, a data schema for the software application. The method includes inserting, by the computing system, the data schema generated by the machine-learned language model into a declarative model associated with the software application.

Another example aspect of the present disclosure is directed to an application development platform implemented by a computing system comprising one or more computing devices and configured to perform operations. The operations include obtaining, by the computing system, a natural language description of a software application. The operations include processing, by the computing system, the natural language description with a machine-learned language model to generate, as an output of the machine-learned language model, a data schema for the software application. The operations include inserting, by the computing system, the data schema generated by the machine-learned language model into a declarative model associated with the software application.

Another example aspect of the present disclosure is directed to one or more non-transitory computer-readable media that collectively store instructions that, when executed by a computing system, cause the computing system to perform operations. The operations include obtaining, by the computing system, a training data pair comprising: a natural language description of a software application and a ground truth data schema for the software application. The operations include processing, by the computing system, the natural language description with a language model to generate, as an output of the language model, a predicted data schema for the software application. The operations include evaluating, by the computing system, a loss function that generates a loss value based on a comparison of the ground truth data schema with the predicted data schema. The operations include modifying, by the computing system, one or more parameter values of the language model based on the loss function.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example application development platform according to example embodiments of the present disclosure.

FIG. 2 depicts a block diagram of an example application development platform according to example embodiments of the present disclosure.

FIG. 3 depicts a block diagram of an example application development platform according to example embodiments of the present disclosure.

FIG. 4 depicts a block diagram of an example technique to train a language model according to example embodiments of the present disclosure.

FIG. 5A depicts a block diagram of an example computing system according to example embodiments of the present disclosure.

FIG. 5B depicts a block diagram of an example computing device according to example embodiments of the present disclosure.

FIG. 5C depicts a block diagram of an example computing device according to example embodiments of the present disclosure.

Reference numerals that are repeated across plural figures are intended to identify the same features in various implementations.

### DETAILED DESCRIPTION

Generally, the present disclosure is directed to systems and methods that leverage a machine-learned language model to perform automated generation and/or modification of a data schema for a software application based on natural language inputs. For example, example implementations of the present disclosure can be implemented as part of or by an application development platform that enables users to develop software applications using low-code or no-code tools.

More particularly, according to an aspect of the present disclosure, an application development platform can obtain a natural language description of a software application. The natural language description can be or include a description of the software application as desired by the user. For example, the natural language description can provide a description of different aspects of the software application such as desired data structures, functions, requirements, data flows, or operations.

The natural language description can be entered or otherwise input by a user. As an example, in some implementations, the application development platform can receive the natural language description from the user via a chatbot interface that enables the user to engage in a textual dialog with a chatbot or other artificial intelligence agent. Enabling the input of the natural language description in such manner can enable the chatbot to ‘interview’ the user and extract their description of the desired software application.

According to another aspect of the present disclosure, the application development platform can process the natural language description with a machine-learned language model to generate, as an output of the machine-learned language model, a data schema for the software application. In particular, the machine-learned language model can leverage its learned understanding of language dynamics to identify the key aspects of the problem as stated in the description and to generate a data schema that has an appropriate structure to address the specified problems.

The data schema can define a data structure for a data source from which the software application retrieves data. As examples, the data source can be various forms of data storage files such as spreadsheets and/or data storage apparatus or mechanisms such various forms of databases (e.g., SQL databases). To provide an example, the data schema can be a SQL specific definition of a set of tables and columns. The definition can specify data types for tables and columns and can include key references between tables.

The application development platform can insert the data schema generated by the machine-learned language model into a declarative model associated with the software application. Then, one or more code generation systems can be employed to generate a set of application code for the software application based on the declarative model that includes the data schema. The set of application code can be deployed or otherwise provided to execute the application.

Thus, aspects of the present disclosure enable a user to provide a high level description, e.g., in a natural language, as an input. The system then leverages a machine-learned language model to produce complete and usable data schemas to model the data needed to facilitate software application described by the user. Further, the user can directly edit the data schema and/or iteratively interact with the model-based system offered by the application development platform to adjust the data schema as the user or their organization matures through a digital transformation, or otherwise to arrive at an improved solution over a number of iterative interactions.

The proposed approach leverages the power of generative language models to assist users with technical skills that they otherwise do not possess. In particular, the model is able to generate highly technical outputs for a user with minimal technical knowledge of data modeling, database languages, and/or software development practices. As examples, the proposed approach can be used to design new data schemas, map existing schemas to intended use cases (e.g., for example calling external APIs), and/or to generate query expressions on an existing schema to compute specific results.

The systems and methods of the present disclosure provide a number of technical effects and benefits. As examples, the proposed approach can save computational resources by reducing the complexity of software development. In particular, the proposed approaches can eliminate the need for extensive custom coding. This can reduce the overall complexity of the codebase, resulting in smaller code sizes and fewer lines of code to be compiled and/or executed, which can save computational resources. Furthermore, reducing the amount of time spent by a human performing code creation can result in a reduced usage of computational resources such as processor cycles or memory usage. Stated differently, the proposed approach will generally result in faster development of the software application, which can reduce the amount of computational resources used over time. More generally, the present disclosure enables more efficient development, execution, and maintenance of applications, resulting in optimized utilization of computational resources.

With reference now to the Figures, example embodiments of the present disclosure will be discussed in further detail.

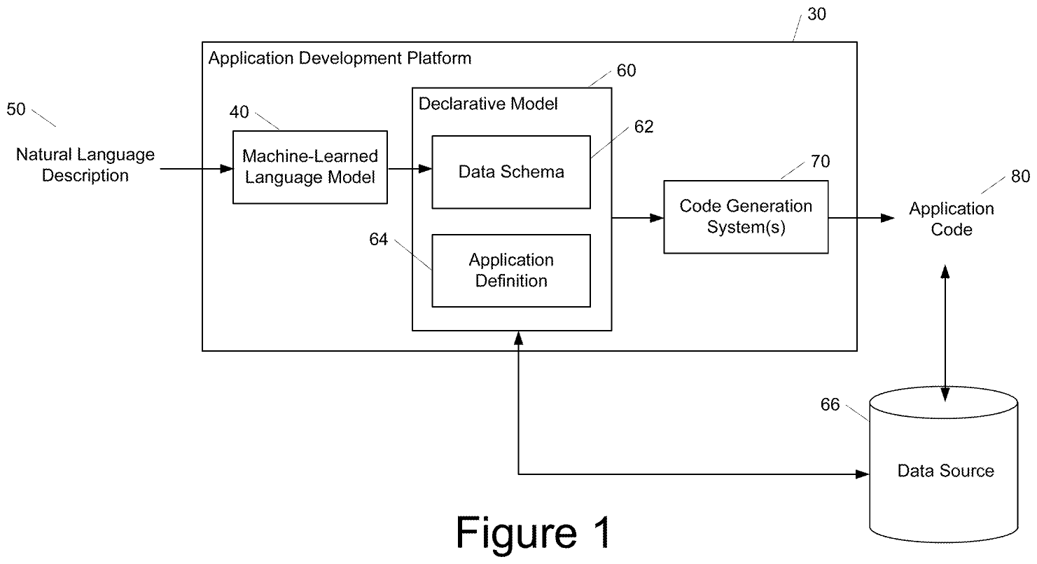

FIG. 1 depicts a block diagram of an example application development platform 30. The application development platform 30 can include a set of tools, technologies, and resources that enables users to create software applications. For example, the application development platform 30 can include programming languages, integrated development environments (IDEs), libraries and frameworks, runtime environments, testing and debugging tools, deployment and DevOps tools, as well as documentation and community resources. These components can provide a unified and organized environment for developers to design, code, test, and deploy applications efficiently.

According to an aspect of the present disclosure, the application development platform 30 can include or be part of a no-code platform that allows users to create software applications (e.g., mobile and web applications) using spreadsheets as a data source 66. For example, the application development platform 30 can enable users to build custom applications without writing code, making it accessible to users with limited programming skills. The application development platform 30 can integrate with various productivity and/or collaboration tools such as spreadsheet applications, text-editing applications, data storage applications, etc. These integrations can enable users to create dynamic, interactive, and data-driven applications for various use cases.

In some implementations, by interacting with the application development platform 30, users can define the structure of their application using a spreadsheet or other data source 66. Users can then configure the application's behavior, user interface, and functionality using a visual interface and a set of predefined actions and workflows. The application development platform 30 can support a wide range of data types, including text, numbers, dates, images, and more, and can provide various features such as data validation, formulas, and workflows for creating robust applications.

According to an aspect of the present disclosure, the application development platform 30 can include or otherwise leverage (e.g., via API calls to a remote system) a machine-learned language model 40. In some implementations, the machine-learned language model can be or can be referred to as a so-called “large language model”. Large language models refer to powerful machine learning models that are capable of processing and generating text on a large scale. These models are typically trained on massive amounts of data, often millions or even billions of sentences, to learn the patterns, structures, and nuances of natural languages.

Language models can be trained using various techniques or architectures, such as recurrent neural networks (RNNs), transformers, or other machine learning algorithms. Language models can be trained to handle a wide range of natural language processing (NLP) tasks, such as text generation, text completion, sentiment analysis, machine translation, question answering, and more. Examples of large language models include BERT (Bidirectional Encoder Representations from Transformers) and T5 (Text-to-Text Transfer Transformer).

According to another aspect of the present disclosure, the application development platform 30 can obtain a natural language description 50 of a software application. The natural language description 50 can be or include a description of the software application as desired by the user. For example, the natural language description 50 can provide a description of different aspects of the software application such as desired data structures, functions, requirements, data flows, or operations.

In some implementations, the natural language description 50 of the computer application is a human-readable explanation or summary of what a particular software application does or is intended to do, expressed in ordinary language that is easily understandable by non-technical individuals. The natural language description 50 can provide a high-level, non-technical overview of the purpose, functionality, and/or features of the application, without using technical jargon, complex terminology, or programming language. It may also highlight any unique or innovative aspects of the application, its target audience or user base, and any relevant use cases or scenarios where the application may be useful.

There are several different interfaces that can be used to receive the natural language description 50 from a user. In one example, a text-based input interface can be used. The user can type or paste text into a text input field and submit it for processing by the application development platform 30.

In another example, voice-based input interfaces can be used. These interfaces can enable users to input natural language through voice commands or speech recognition. Users speak their input using a microphone or other voice input device, and the application development platform 30 processes the speech to extract the natural language description 50.

In another example, the application development platform 30 can enable the user to provide multimodal input. For example, in addition to the natural language description 50, the application development platform 30 can enable users to input data of other modalities, such as images, videos, or gestures. Users can combine different modalities to provide input, such as describing an image, providing voice commands while pointing to a location on a map, or using gestures to indicate actions or selections.

Finally, in some implementations, a natural language interface (NLI) can be used. An NLI allows users to input natural language directly into the application development platform 30 using conversational language, similar to having a conversation with a human. Users can ask questions, make requests, or provide information in a conversational manner, and the application development platform 30 processes the input using natural language processing (NLP) techniques to understand the intent and respond accordingly. NLI interfaces can include the use of chatbots or artificial intelligence assistants.

Thus, as one example, the application development platform 30 can receive the natural language description 50 from the user via a chatbot interface that enables the user to engage in a textual dialog with a chatbot or other artificial intelligence agent. Enabling the input of the natural language description in such manner can enable the chatbot to ‘interview’ the user and extract their description of the desired software application.

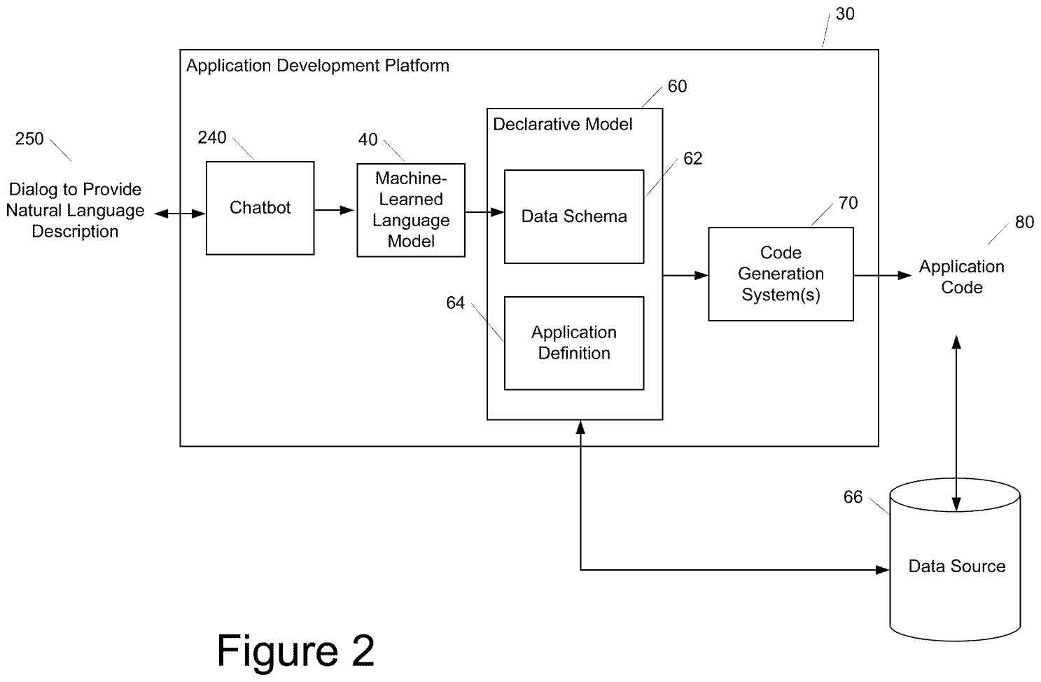

An example of this approach is shown in FIG. 2. In particular, in FIG. 2, a user (e.g., developer) is able to engage in a dialog 250 with a chatbot 240 in order to provide a natural language description of the desired software application.

The chatbot 240 can be a computer program that uses natural language processing (NLP) and artificial intelligence (AI) techniques to simulate conversation with users. The chatbot 240 can be designed to engage in text-based or voice-based conversations, and it can be used guide a user through the task of providing a description of the desired software.

For example, the chatbot 240 can engage in a conversational flow that involves asking questions and receiving responses. This process can also be referred to as an interview or dialog and can include one or more rounds of questions and answers. For example, throughout the interview process, the chatbot 240 can leverage its AI capabilities to understand the user's input, extract relevant information, and guide the user through the task in a conversational and user-friendly manner.

Referring back to FIG. 1, according to an aspect of the present disclosure, the application development platform 40 can process the natural language description 50 with the machine-learned language model 40 to generate, as an output of the machine-learned language model 40, a data schema 62 for the software application. In particular, the machine-learned language model 40 can leverage its learned understanding of language dynamics to identify the key aspects of the problem as stated in the description 50 and to generate a data schema 62 that has an appropriate structure to address the specified problems.

The application development platform 30 can insert the data schema 62 generated by the machine-learned language model 40 into a declarative model 60 associated with the software application. More particularly, the application development platform 30 can maintain and assist the user in creating or editing a declarative model 60 for the software application being developed. The declarative model can also include the data schema 62 and an application definition 64.

The declarative model 60 can be a representation of a software system's behavior or logic, typically expressed using high-level concepts, rules, or constraints. The declarative model 60 can describe what the software application should do, without specifying how it should do it. The declarative model 60 can define the desired state or outcome of a system, rather than the step-by-step instructions for achieving that state. The declarative model 60 can be used in domains such as database management, rule-based systems, and workflow automation.

As one example, in a database management system, the declarative model 60 can define the relationships between different data entities, the constraints on data values, and the operations that can be performed on the data, without specifying the detailed implementation or execution logic.

The data schema 62 can define the structure, format, and/or relationships of the data used in the software application. The data schema 62 can include data entities, attributes, and their interdependencies. For example, the data schema 62 can outline the design and organization of a data source 66 associated with the software application, including the tables, fields, relationships, constraints, and other elements that define how data is stored, retrieved, and managed in the data source 66. The data schema 62 can be represented using various techniques such as entity-relationship diagrams, class diagrams, or schema definitions.

The data schema 62 can define the logical structure of the data source 66 and/or the physical structure of the data source 66. The logical structure can define how the data is organized and represented conceptually. The physical structure of the data source 66 can define how the data is stored on the underlying storage media, such as disks or memory.

The data source 66 can be any source of stored data and can be structured according to a number of different formats including various types of databases and/or data storage formats such as, for example, spreadsheets.

As one example, the data source 66 can be a SQL database. SQL, which stands for Structured Query Language, is a domain-specific programming language used for managing and querying relational databases. It is the standard language for managing relational databases, which are widely used for storing, retrieving, and manipulating structured data.

SQL provides a set of commands, known as SQL queries, for performing various operations on a relational database, such as creating, updating, and deleting data, as well as querying and retrieving data based on specific criteria. SQL is a declarative language, meaning that users specify what they want to do with the data, and a database management system (DBMS) takes care of the details of how to do it.

Some common SQL operations include SELECT for retrieving data, INSERT for inserting new data, UPDATE for modifying existing data, and DELETE for deleting data from a database. SQL also supports advanced features, such as joining multiple tables, aggregating data, sorting, filtering, and performing transactions, among others.

The data source 66 can alternatively be structured according to other types of database systems that use different query languages and data models. One example is a NoSQL database. These databases use non-relational data models and do not rely on SQL for querying data. Another example is NewSQL databases. These databases are relational databases that provide alternative SQL-based query languages or additional features on top of traditional SQL. Another example is a graph database. These databases are designed for storing and querying graph data, where data entities are represented as nodes and their relationships as edges. Another example is object-relational mapping (ORM) frameworks. These are libraries or tools that allow developers to interact with relational databases using object-oriented programming languages, such as Python, Java, or Ruby, instead of writing SQL queries directly.

The data scheme 62 can specify relationships between objects (e.g., usually using tables) to establish how they are related or connected to each other. Various types of relationships can be defined in the data schema 62 such as one-to-one relationships; one-to-many relationships; many-to-many relationships; and/or self-referential relationships.

Referring still to FIG. 1, the application definition 64 can refer to or include the components of the declarative model 60 that define the behavior, rules, workflow, user interface, and/or configuration settings of the software application. As examples, the application definition 64 can include rules, a workflow or process model, user interface components, configuration settings, and/or a security model, which collectively define the desired state or behavior of the application.

As one example, the application definition 64 can include rules. These are the rules and logic that govern the behavior of the application. Rules may include conditions, constraints, calculations, validations, and other logic that define how the application should operate based on the input data and desired outcomes. Rules may be expressed in a declarative format, such as through rule-based engines or configuration files.

As another example, the application definition 64 can include a workflow or process model. This component defines the flow of activities or processes in the application. It describes how different tasks or steps are executed, their sequence, dependencies, and interactions. Workflow or process models may be represented using visual diagrams, flowcharts, or process definitions in a declarative format, such as Business Process Model and Notation (BPMN) or Workflow Definition Language (WDL).

As another example, the application definition 64 can include user interface (UI) components. These are the components that define the visual and/or interactive elements of the application's user interface. UI components may include screens, forms, buttons, menus, and other UI elements that allow users to interact with the application. The declarative model for UI components may be defined using UI frameworks, markup languages, or visual designers.

As another example, the application definition 64 can include configuration settings. These are the settings and/or configurations that define the behavior and/or settings of the application. Configuration settings may include parameters, options, preferences, and/or other settings that can be adjusted without modifying the application's code. Configuration settings may be stored in configuration files, databases, or other data source 66s in a declarative format.

As another example, the application definition 64 can include a security model. This component can define the security settings, access controls, and/or authentication/authorization mechanisms for the application. It can include the definition of user roles, permissions, and/or security policies that govern the access and actions allowed in the application. The security model can be defined in a declarative format, such as through security configuration files or access control lists (ACLs).

As another example, the application definition 64 can include a deployment and infrastructure model. This component can define the deployment requirements, configuration, and/or infrastructure dependencies of the application. It can include information about the target deployment environment, such as servers, databases, networks, and/or other infrastructure components. The deployment and infrastructure model can be defined using configuration files, templates, or scripts in a declarative format.

In yet further examples, the application definition 64 can include one or more application programming interface (API) calls. The API calls can be made against or with reference to the data source 66. For example, in the declarative model 60, API calls can be used to make changes to the underlying data of the data source 66 or can be defined with reference to and/or act upon the data schema 62 or other aspects of the declarative model 60. The API calls can specify the endpoints, input parameters, output responses, authentication, and other details of the API. The specific API calls and their syntax may vary depending on the platform or system being used to implement the declarative model 60.

One example API call is a Create call. This API call can be used to create new objects or records in the data source 66. It typically involves specifying the data or configuration for the new object or record, and making a POST request to the data source 66 with the necessary data.

Another example API call is an Update call. This API call can be used to update existing objects or records in the data source 66. It typically involves specifying the ID or unique identifier of the object or record to be updated, along with the updated data or configuration, and making a PUT or PATCH request to the data source 66 with the necessary data.

Another example API call is an Delete call. This API call is used to delete objects or records from the data source 66. It typically involves specifying the ID or unique identifier of the object or record to be deleted, and making a DELETE request to the data source 66.

Another example API call is an Query call. This API call can be used to retrieve data or objects from the data source 66 based on specific criteria or filters. It typically involves making a GET request to the data source 66 with the desired query parameters or filters.

Another example API call is an Batch Operations call. Some declarative model APIs may support batch operations, which allow multiple operations (e.g., create, update, delete) to be combined into a single API call for improved efficiency. Batch operations typically involve specifying an array of operations with their respective data or configuration, and making a single request to the data source 66.

In some implementations, the application definition 64 can include one or more semantically-driven API calls. Semantically-driven API calls refer to API calls that are based on the meaning or semantics of the data being processed, rather than simply manipulating raw data or executing predefined actions. Semantically-driven APIs leverage natural language processing (NLP) or other semantic technologies to extract meaning from data and enable more sophisticated and context-aware interactions with the API.

In some implementations, semantically-driven API calls can operate as follows: Input data can be provided to the API call, which could be in the form of text, speech, images, or other types of data. This input data can contain information from which meaning can be extracted or on which operations can be performed. The API call can perform semantic processing on the input data, using NLP or other semantic technologies. This can include tasks such as entity recognition, sentiment analysis, language translation, intent detection, or other semantic operations, depending on the capabilities of the API. The API call can extract meaningful information or insights from the input data based on the semantic processing. For example, it may identify entities like names, dates, locations, or other relevant information, determine sentiment or emotional tone, translate text to different languages, or detect the intent behind a user's query. Based on the extracted meaning, the API call can enable context-aware operations or actions. These could include making decisions, performing actions, generating responses, or triggering events, all driven by the understanding of the meaning or semantics of the input data.

In some implementations, the natural language description 50 can be augmented with additional information such as additional information about an existing version of the data schema 62. This may be useful when the user is seeking to edit or modify an existing data schema rather than create an entirely new data schema. For example, a user may be able to iteratively interact with the language model 40 to alter the data schema over time.

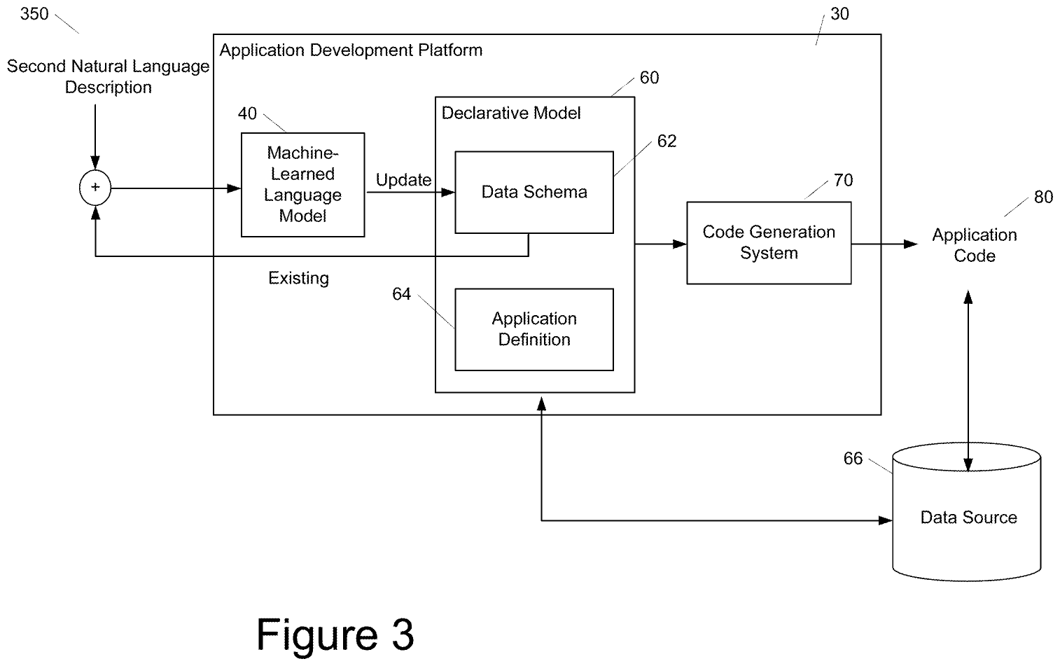

An example of this approach is shown in FIG. 3. In particular, as shown in FIG. 3, the user can provide a second natural language description 350. The second natural language description 350 may be an additional description or requested change to the current or existing data schema 62. Information about the existing data schema 62 can be combined (e.g., appended or concatenated) with the second natural language description 350. In such manner, information about the current or existing data schema 62 can be provided as context to the machine-learned language model 40. In response, the machine-learned language model 40 can output an updated data schema 62 and/or one or more edits and/or additions to the current or existing data schema 62. The data schema 62 can be updated based on the output of the language model 40. For example, updating the data schema 62 can include editing, amending, or replacing the data schema 62 based on the output of the language model 40.

Additional iterations of input and updates can be performed as well. Other data can be added as context for the language model 40 as well.

Referring back to FIG. 1, once the declarative model 60 has been generated for the software application, the application development platform 30 can implement one or more code generation systems 70 to generate a set of application code 80 from the declarative model 60. The application code 80 can implement the application (e.g., as described by the declarative model 60) in any number of different application deployment settings. In particular, the platform 30 and/or a user of the platform can specify different deployment parameters such as different device paradigms (e.g., mobile vs. desktop), different operating systems, different programming languages, and/or other parameters. In response, the one or more code generation system 70 can process the declarative model 60 and the specified deployment parameters to generate the application code 80 that implements the software application (e.g., as described by the declarative model 60) in the specified deployment setting. Thereafter, the set of application code 80 can be deployed or otherwise provided to execute the application.

The code generation system(s) 70 can include one or more of various different tools or technologies that create the application code 80 based on the declarative model 60.

In one example the code generation system(s) 70 can be or include a model-driven development (MDD) framework. In these frameworks, the declarative model 60 can be represented in or using a domain-specific language (DSL) or a graphical modeling language.

In another example the code generation system(s) 70 can be or include configuration-driven frameworks. These frameworks allow developers to configure the behavior or settings of an application using declarative configuration files or settings, which are interpreted at runtime to generate the corresponding application behavior.

In another example the code generation system(s) 70 can be or include domain-specific language (DSL) compilers. DSLs are specialized programming languages designed for specific domains or problem areas. The declarative model 60 can be expressed in DSLs, and compilers or interpreters for these DSLs can automatically generate application code from the declarative model 60.

In another example the code generation system(s) 70 can be or include markup language processors. Markup languages such as XML, JSON, or YAML can be used to represent the declarative model 60 and processors or interpreters for these markup languages can automatically generate the application code 80 from the declarative model 60. Examples of markup language processors include XSLT (Extensible Stylesheet Language Transformations) for generating XML-based output, and JSON templates for generating code from JSON-based configuration files.

Overall, the code generation system(s) 70 can be used to automatically transform the declarative model 60 into the application code 80, helping to improve productivity, maintain consistency, and reduce errors in software development. In particular, one concept in these systems is that developers specify the desired behavior or outcome of the application using the declarative model 60, and the code generation system 70 generates the corresponding code 80 based on the declarative model 60. This can result in faster development cycles, increased productivity, and easier maintenance and updates, as changes to the application's behavior can be made by modifying (e.g., via interaction with the machine-learned language model 40) the declarative model 60, without requiring extensive manual coding or recompilation of the actual application code 80.

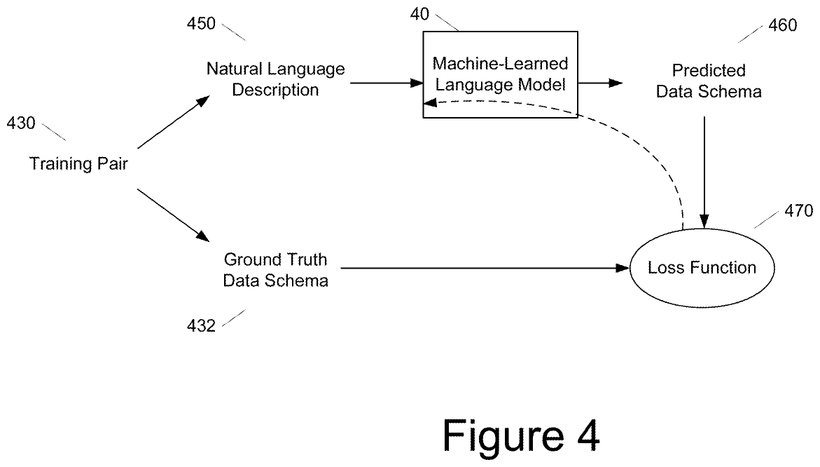

FIG. 4 depicts a block diagram of an example technique to train a language model 40 according to example embodiments of the present disclosure. In particular, FIG. 4 depicts an example supervised learning approach that uses a set of supervised training data. The set of supervised training data includes pairs of examples of inputs and their corresponding outputs. These pairs are used to train the language model 40 to learn the underlying patterns or relationships between inputs and outputs, so that the model can make predictions or generate outputs for new, unseen inputs.

In particular, as shown in FIG. 4, a computing system can obtain a training data pair 430. The training data pair 430 can include a natural language description 450 of a software application and a ground truth data schema 432 for the software application. The ground truth data schema 432 represents the ground truth or the correct outputs for the given natural language description 450, and the ground truth data schema 432 serves as the reference for the model 40 to learn from during training.

The computing system can process the natural language description 450 with the language model 40 to generate, as an output of the language model 40, a predicted data schema 460 for the software application.

The computing system can evaluate a loss function 470 that generates a loss value based on a comparison of the ground truth data schema 432 with the predicted data schema 460. For example, the loss function 470 can be a language modelling loss function such as, for example: cross-entropy loss, perplexity loss, binary cross-entropy loss, Kullback-Leibler (KL) Divergence loss, Mean Squared Error (MSE) loss, and/or others. The loss function 470 can measure a performance of the model 40 is predicting the ground truth data schema 432.

The computing system can modify one or more parameter values of the language model 40 based on the loss function 470. For example, as illustrated using the dashed line, the loss function 470 can be backpropagated through the language model 40. The process shown in FIG. 4 can be repeated for any number of training pairs over any number of training iterations.

In some implementations, the natural language description 450 of the software application can have been generated by a human annotator. For example, a human annotator may be asked to describe, using natural language, an existing software application. The existing software application may have an existing data schema. The natural language description provided by the human annotator can be paired with the existing data schema to form a training pair. This process can be performed on a number of existing software applications to generate a training dataset of training pairs having the structure shown in FIG. 4.

In some implementations, the training process shown in FIG. 4 may be performed as fine-tuning on a pre-trained language model 40. Fine-tuning the language model 40 can include training the pre-trained model 40 on additional data (e.g., the training pair 430) to adapt it to a specific task or domain (e.g., to generate predicted data schemas).

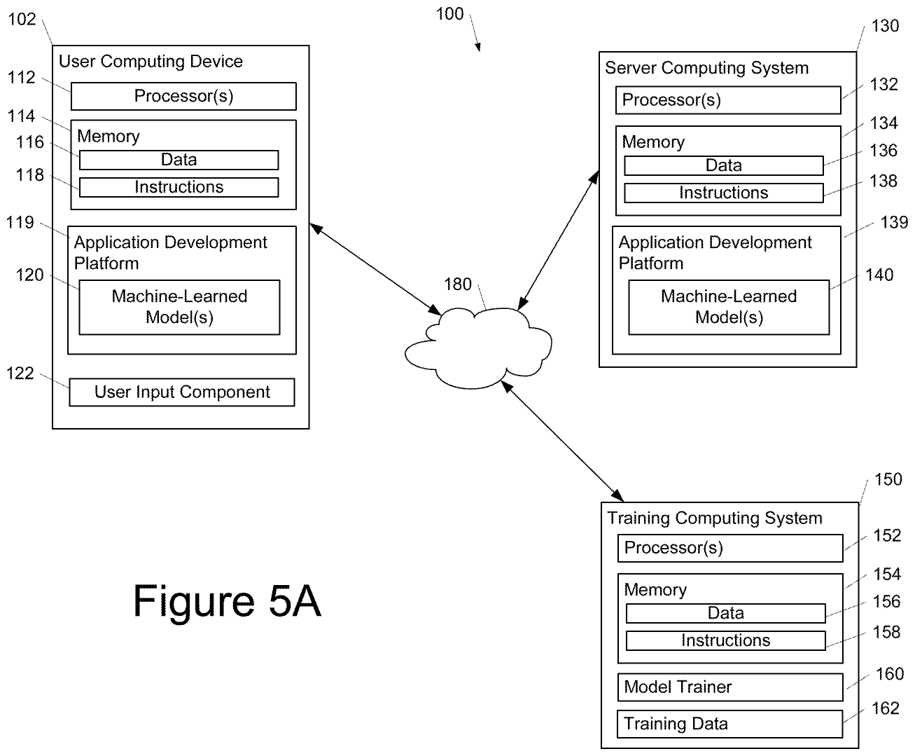

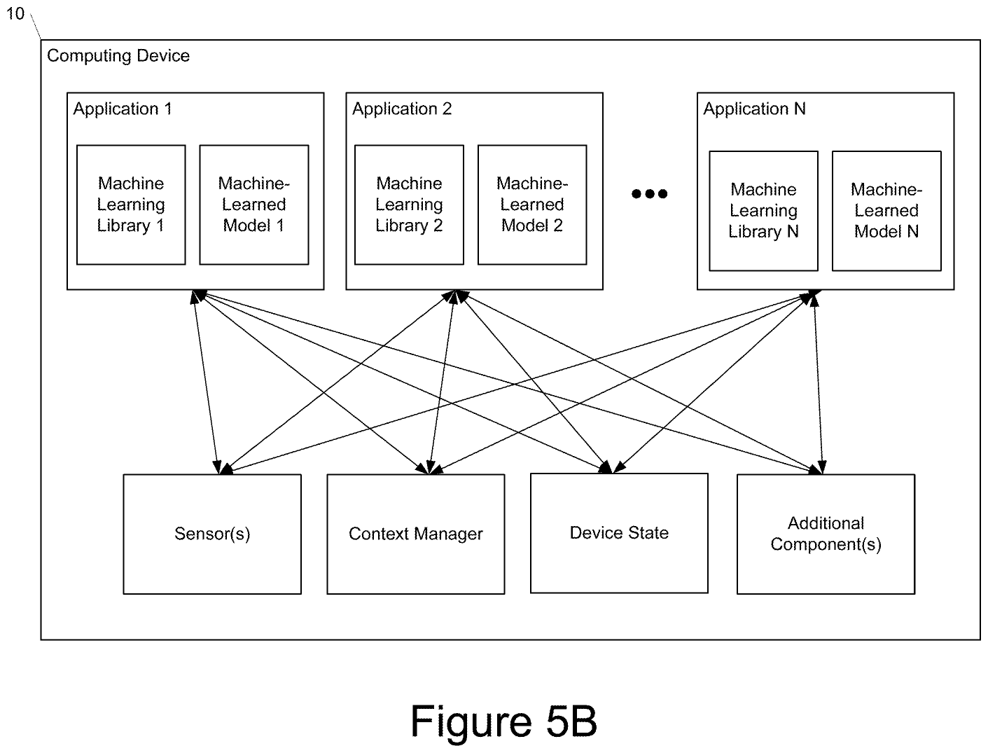

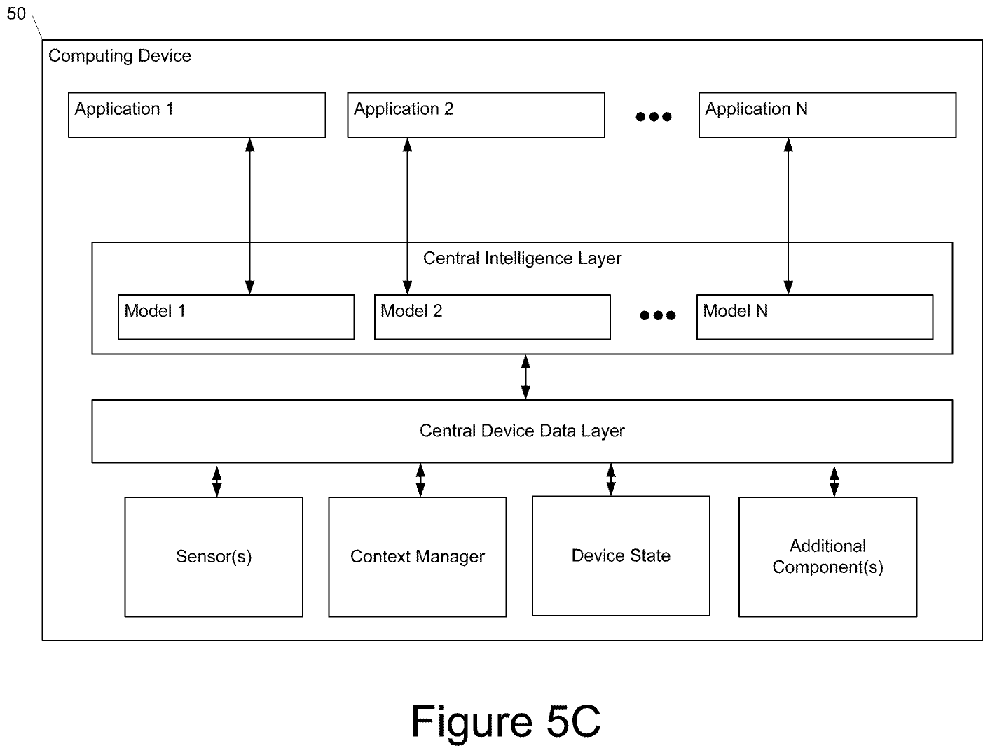

FIG. 5A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include some or all of an application development platform 119. Example application development platforms 119 are discussed with reference to FIGS. 1-3. Alternatively or additionally, the server computing system 130 can store or include some or all of an application development platform 139. Example application development platforms 139 are discussed with reference to FIGS. 1-3. Thus, the application development platform can be located at the user computing device 102 and/or at the server computing system 130. The application development platform 119 and/or 139 can be implemented in hardware, firmware, and/or software controlling a general purpose processor. For example, in some implementations, the application development platform 119 and/or 139 includes program files stored on a storage device, loaded into a memory and executed by one or more processors. In other implementations, the application development platform 119 and/or 139 includes one or more sets of computer-executable instructions that are stored in a tangible computer-readable storage medium such as RAM, hard disk, or optical or magnetic media.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIGS. 1-4.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel application development across multiple instances of an application development platform).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., an application development service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1-4.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, training pairs as described with reference to FIG. 4.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 5A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 5B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 5B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 5C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 5C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 5C, the central device data layer can communicate with a number of other components of the computing device, such as, for example, one or more sensors, a context manager, a device state component, and/or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for automated software development, the method comprising:
obtaining, by a computing system comprising one or more computing devices, a natural language description of a software application;
processing, by the computing system, the natural language description with a machine-learned language model to generate, as an output of the machine-learned language model, a data schema for the software application; and
inserting, by the computing system, the data schema generated by the machine-learned language model into a declarative model associated with the software application.

2. The computer-implemented method of claim 1, further comprising:
generating, by a code generation system of the computing system, a set of application code for the software application based on the declarative model that includes the data schema.

3. The computer-implemented method of claim 1, wherein the software application operates to retrieve data from a data source, and wherein the data source is structured according to the data schema.

4. The computer-implemented method of claim 3, wherein the data source comprises a spreadsheet.

5. The computer-implemented method of claim 3, wherein the data source comprises a SQL database.

6. The computer-implemented method of claim 1, wherein the operations further comprise:
obtaining, by the computing system, a second natural language description of the software application, wherein the second natural language description specifies one or more requested changes to the software application;
processing, by the computing system, the second natural language description with the machine-learned language model to generate, as an output of the machine-learned language model, an updated data schema for the software application; and
inserting, by the computing system, the updated data schema generated by the machine-learned language model into the declarative model associated with the software application.

7. The computer-implemented method of claim 6, wherein processing, by the computing system, the second natural language description with the machine-learned language model comprises:
concatenating, by the computing system, the data schema with the second natural language description to generate a concatenated input; and
processing, by the computing system, the concatenated input with the machine-learned language model to generate, as the output of the machine-learned language model, the updated data schema for the software application.

8. The computer-implemented method of claim 1, wherein the natural language description comprises a textual description contained in a dialog between a user and a chatbot.

9. An application development platform implemented by a computing system comprising one or more computing devices and configured to perform operations, the operations comprising:
obtaining, by the computing system, a natural language description of a software application;
processing, by the computing system, the natural language description with a machine-learned language model to generate, as an output of the machine-learned language model, a data schema for the software application; and
inserting, by the computing system, the data schema generated by the machine-learned language model into a declarative model associated with the software application.

10. The application development platform of claim 9, further comprising:
generating, by a code generation system of the computing system, a set of application code for the software application based on the declarative model that includes the data schema.

11. The application development platform of claim 9, wherein the software application operates to retrieve data from a data source, and wherein the data source is structured according to the data schema.

12. The application development platform of claim 11, wherein the data source comprises a spreadsheet.

13. The application development platform of claim 11, wherein the data source comprises a SQL database.

14. The application development platform of claim 9, wherein the operations further comprise:
obtaining, by the computing system, a second natural language description of the software application, wherein the second natural language description specifies one or more requested changes to the software application;
processing, by the computing system, the second natural language description with the machine-learned language model to generate, as an output of the machine-learned language model, an updated data schema for the software application; and
inserting, by the computing system, the updated data schema generated by the machine-learned language model into the declarative model associated with the software application.

15. The application development platform of claim 14, wherein processing, by the computing system, the second natural language description with the machine-learned language model comprises:
concatenating, by the computing system, the data schema with the second natural language description to generate a concatenated input; and
processing, by the computing system, the concatenated input with the machine-learned language model to generate, as the output of the machine-learned language model, the updated data schema for the software application.

16. The application development platform of claim 9, wherein the natural language description comprises a textual description contained in a dialog between a user and a chatbot.

17. One or more non-transitory computer-readable media that collectively store instructions that, when executed by a computing system, cause the computing system to perform operations, the operations comprising:
obtaining, by the computing system, a training data pair comprising: a natural language description of a software application and a ground truth data schema for the software application;
processing, by the computing system, the natural language description with a language model to generate, as an output of the language model, a predicted data schema for the software application;
evaluating, by the computing system, a loss function that generates a loss value based on a comparison of the ground truth data schema with the predicted data schema; and
modifying, by the computing system, one or more parameter values of the language model based on the loss function.

18. The one or more non-transitory computer-readable media of claim 17, wherein the natural language description of the software application was generated by a human annotator.

19. The one or more non-transitory computer-readable media of claim 17, wherein the language model comprises a pre-trained language model and said modifying comprises fine-tuning the language model.

20. The one or more non-transitory computer-readable media of claim 19, wherein fine-tuning the language model comprises training the language model on a custom dataset that provides example data schemas responsive to example natural language descriptions.
